(19) United States
(12) Patent Application Publication
(10) Pub. No.: US 2023/0367098 A1
(43) Pub. Date: Nov. 16, 2023

(54) METHODS AND SYSTEMS FOR AUTOMATED DYNAMIC LENS UTILIZATION

(71) Applicant: GM GLOBAL TECHNOLOGY OPERATIONS LLC, Detroit, MI (US)

(72) Inventors: Brian Yousif-Dickow, Farmington Hills, MI (US); Andrew W Averhart, Redford, MI (US); Sai Vishnu Aluru, Commerce Twp, MI (US); Sravan Daruri, Walled Lake, MI (US)

(73) Assignee: GM GLOBAL TECHNOLOGY OPERATIONS LLC, Detroit, MI (US)

(21) Appl. No.: 17/663,509

(22) Filed: May 16, 2022

(51) Int. Cl. G02B 7/08; G02B 7/02; B60R 11/04

(52) U.S. Cl. CPC G02B 7/08; G02B 7/023; B60R 11/04

(57) ABSTRACT

Methods and systems are provided for controlling a position of a lens of a camera of a vehicle. In one embodiment, a method includes: storing, in a data storage device, a first lens position associated with the lens of the camera; receiving, by a processor, sensor data generated by at least one sensor of the vehicle; determining, by the processor, a desire for a change in lens position based on the sensor data; selecting, by the processor, the camera from a plurality of cameras of the vehicle based on the desire for change in lens position; determining, by the processor, a second lens position based on conditions associated with the desire for the change in lens position and the first lens position; and generating, by the processor, control data to control the position of the lens based on the second lens position.

### INTRODUCTION

The technical field generally relates to cameras and, more specifically, to methods and systems for automated and dynamic utilization of a lens of a camera of a vehicle.

Vehicles are typically equipped with one or more cameras to assist a driver with viewing an environment surrounding the vehicle. For example, cameras can be disposed at various locations about the vehicle to enable a driver to view the environment to the left side, the right side, the front and/or the rear environment of the vehicle. Cameras are typically limited by either field of view or pixel density. For example, a camera may provide a high pixel density, but a small field of view and another camera may provide a large field of view, but a low pixel density.

Some cameras include an adjustable lens. A position of the lens affects the pixel density at certain locations of the image. It is desirable to incorporate an adjustable lens into a camera of the vehicle. It is further desirable to provide methods and systems for automated and dynamic utilization of the lens of the vehicle camera for improved field of view and pixel density. Furthermore, other desirable features and characteristics of the present invention will become apparent from the subsequent detailed description of the invention and the appended claims, taken in conjunction with the accompanying drawings and this background of the invention.

### SUMMARY

Methods and systems are provided for controlling a position of a lens of a camera of a vehicle. In one embodiment, a method includes: storing, in a data storage device, a first lens position associated with the lens of the camera; receiving, by a processor, sensor data generated by at least one sensor of the vehicle; determining, by the processor, a desire for a change in lens position based on the sensor data; selecting, by the processor, the camera from a plurality of cameras of the vehicle based on the desire for change in lens position; determining, by the processor, a second lens position based on conditions associated with the desire for the change in lens position and the first lens position; and generating, by the processor, control data to control the position of the lens based on the second lens position.

In various embodiments, the sensor data includes image data generated by at least one of the camera and one or more other cameras of the vehicle.

In various embodiments, the sensor data includes vehicle data that indicates an observable condition of the vehicle.

In various embodiments, the determining the second lens position is further based on a position of the camera relative to the vehicle.

In various embodiments, the determining the desire for change in lens position is based on a determination of at least one of a full and partial blockage of at least one of the plurality of cameras.

In various embodiments, the determining the desire for change in lens position is based on a determination that at least one of a full and partial view from a vehicle mirror is unavailable.

In various embodiments, the determining the desire for change in lens position is based on a determination that an interesting object is at least one of partially or fully outside of a field of view of at least one of the plurality of cameras.

In various embodiments, the selecting the camera from the plurality of cameras of the vehicle is based on a condition associated with the desire for change in lens position. In various embodiments, the selected camera is a camera associated with the condition. In various embodiments, the selected camera is a camera other than a camera associated with the condition.

In another embodiment, a system includes: a non-transitory computer readable medium configured to store parameters associated with the lens; and a computer system onboard the vehicle and configured to, by a processor: store a first lens position associated with the lens of the camera; receive sensor data generated by at least one sensor of the vehicle; determine a desire for a change in lens position based on the sensor data; select the camera from a plurality of cameras of the vehicle based on the desire for change in lens position; determine a second lens position based on conditions associated with the desire for the change in lens position and the first lens position; and generate control data to control the position of the lens based on the second lens position.

In various embodiments, the sensor data includes image data generated by at least one of the camera and one or more other cameras of the vehicle.

In various embodiments, the sensor data includes vehicle data that indicates an observable condition of the vehicle.

In various embodiments, the determination of the second lens position is further based on a position of the camera relative to the vehicle.

In various embodiments, the determination of the desire for change in lens position is based on a determination of at least one of a full and partial blockage of at least one of the plurality of cameras.

In various embodiments, the determination of the desire for change in lens position is based on a determination that at least one of a full and partial view from a vehicle mirror is unavailable.

In various embodiments, the determination of the desire for change in lens position is based on a determination that an interesting object is at least one of partially or fully outside of a field of view of at least one of the plurality of cameras.

In various embodiments, the selection of the camera from the plurality of cameras of the vehicle is based on a condition associated with the desire for change in lens position. In various embodiments, the selected camera is a camera associated with the condition. In various embodiments, the selected camera is a camera other than a camera associated with the condition.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a camera system, in accordance with various embodiments;

FIG. 2 is a dataflow diagram illustrating elements of the camera system of the vehicle of FIG. 1, in accordance with various embodiments; and

FIG. 3 is a flowchart of a process for positioning a lens of a camera as performed by the camera system of the vehicle of FIGS. 1 and 2, in accordance with exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

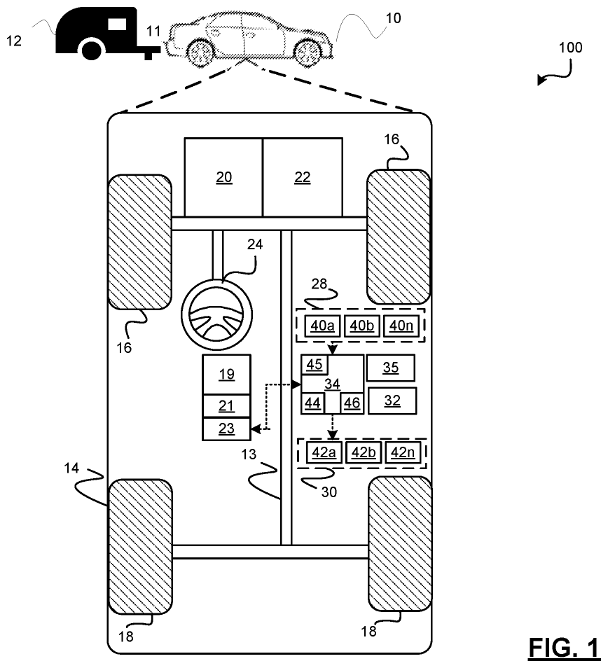

With reference to FIG. 1, a camera system shown generally at 100 is associated with a vehicle 10 in accordance with various embodiments. The vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In various embodiments, the vehicle 10 may also comprise other types of mobile platforms and is not limited to an automobile.

In various embodiments, the vehicle 10 may be associated with a trailer 12 capable of hauling a load. As can be appreciated, the trailer 12 may any type of towable application having one or more wheels and is not limited to any one embodiment. The vehicle 10 is configured to couple to and connect to the trailer 12 via a connection apparatus 11 and is configured to tow the trailer 12. In various embodiments, the connection apparatus 11 comprises a hitch. In various other embodiments, the connection apparatus 11 comprises one or more other types of systems, such as a gooseneck for a fifth wheel trailer, and so on. In various embodiments, the connection apparatus 11 further comprises a wiring harness configured to communicate power and/or communication signals to and from components of the trailer 12.

As depicted in FIG. 1, the exemplary vehicle 10 generally includes a chassis 13, a body 14, front wheels 16, and rear wheels 18. The body 14 is arranged on the chassis 13 and substantially encloses components of the vehicle 10. The body 14 and the chassis 13 may jointly form a frame. The wheels 16-18 are each rotationally coupled to the chassis 13 near a respective corner of the body 14.

The vehicle 10 further includes a propulsion system 20, a transmission system 22, a steering system 24, a sensor system 28, an actuator system 30, at least one data storage device 32, at least one controller 34, and a display system 35. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior and/or interior environment of the vehicle and/or of the vehicle itself. The sensing devices 40a-40n can include, but are not limited to, radars, lidars, global positioning systems, optical cameras, thermal cameras, ultrasonic sensors, inertial measurement units, pressure sensors, position sensors, speed sensors, and/or other sensors. In various embodiments, the sensor system 28 includes the one or more cameras 19 configured to sense an environment of the vehicle 10 and to generate image data based thereon. For example, one or more cameras 19 may be fixed to a location at a rear end of the vehicle 10, one or more cameras 19 may be fixed to a location at a left side and/or right side of the vehicle 10, and/or one or more cameras may be fixed to a location at a front of the vehicle 10. In various embodiments, one or more of the cameras 19 includes an adjustable lens 21. The adjustable lens 21 is configured to rotate in a clockwise or counterclockwise direction relative to the camera 19.

The actuator system 30 includes one or more actuator devices 42a-42n that control one or more vehicle features such as, but not limited to, the propulsion system 20, the transmission system 22, and the steering system 24. In various embodiments, the vehicle features can further include interior and/or exterior vehicle features such as, but are not limited to, doors, a trunk, mirrors, and cabin features such as air, music, lighting, etc. (not numbered). In various embodiments, the vehicle features include a camera lens adjustment system 23 that rotates the camera lens to positions between 0 and 360 degrees in a clockwise or counterclockwise direction.

The data storage device 32 stores data for use in controlling the vehicle 10. In various embodiments, the data storage device 32 stores defined values for controlling the vehicle 10 and/or defined values for the cameras 19 of the vehicle 10. As can be appreciated, the data storage device 32 may be part of the controller 34, separate from the controller 34, or part of the controller 34 and part of a separate system.

The controller 34 includes at least one processor 44, a communication bus 45, a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. The bus 45 serves to transmit programs, data, status and other information or signals between the various components of the vehicle and/or trailer. The bus 45 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, one or more instructions of the controller 34 are embodied in the camera system 100 and, when executed by the processor 44, receive data from the sensor system 28 and process the data in order to generate control data for controlling a position of the lens 21 of one or more of the cameras 19. The position is controlled in order to dynamically maximize the pixel density of an image produced by the camera 19 in order to improve the field of view offered by the cameras 19. The one or more instructions are further configured to modify the reading format of data received from the camera 19 based on the position of the lens 21. In other words, the reading format is changed to correspond to the position of the lens 21.

As can be appreciated, that the controller 34 may otherwise differ from the embodiment depicted in FIG. 1. For example, the controller 34 may be coupled to or may otherwise utilize one or more remote computer systems and/or other control systems, for example as part of one or more of the above-identified vehicle devices and systems. It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 44) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 34 may also otherwise differ from the embodiment depicted in FIG. 1, for example in that the computer system of the controller 34 may be coupled to or may otherwise utilize one or more remote computer systems and/or other control systems.

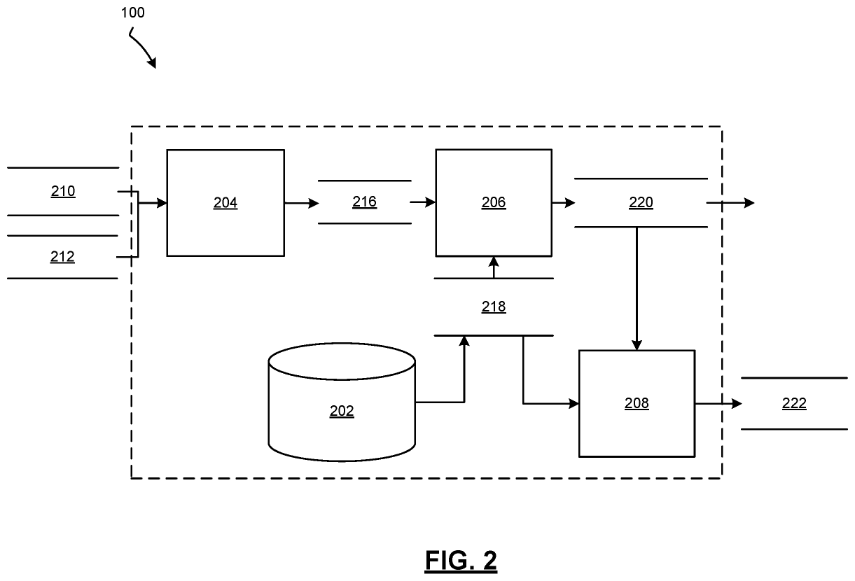

With reference to FIG. 2 and with continued reference to FIG. 1, a dataflow diagram illustrates elements of the camera system 100 of FIG. 1 in accordance with various embodiments. As can be appreciated, various embodiments of the camera system 100 according to the present disclosure may include any number of modules embedded within the controller 34 which may be combined and/or further partitioned to similarly implement systems and methods described herein. Furthermore, inputs to the camera system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like. In various embodiments, the camera system 100 includes a camera data datastore 202, a change enablement module 204, a lens position determination module 206, and a lens control module 208.

In various embodiments, the camera data datastore 202 stores information about the location and orientation of the cameras 19 relative to the vehicle 10 and/or information about the lenses 21, such as a default lens position.

In various embodiments, the change enablement module 204 receives as input image data 210 and vehicle data 212. The image data 210 includes image frames generated by the cameras 19 of the vehicle 10. The vehicle data 212 includes various data indicating a condition of the vehicle 10 such as vehicle speed, vehicle location, vehicle feature position (e.g., side mirror position, liftgate position, etc.), vehicle elevation, etc.

The change enablement module 204 evaluates the image data 210 and/or the vehicle data 212 in order to determine whether a change in a position of a lens 21 of one or more of the cameras 19 is desirable. For example, a change in lens position may be determined as desirable when a partial or full view of one of the cameras 19 is blocked (e.g., by ice, snow, or dirt sensed on the camera 19 or by another object sensed in front of the camera 19), when a partial or full view from a vehicle mirror is unavailable (e.g., the position of the side view mirrors are sensed as pulled in, the position of the liftgate is sensed as open, etc.), and when an interesting object is partially or fully outside of the field of view (e.g., due to other objects determined to be blocking the interesting object, due to a determined change in elevation of the vehicle 10 relative to the interesting object, etc.). When a change in position is desired, the change enablement module 204 generates change data 216. The change data 215 includes an indication of the desire for a change, and information about the condition that initiates the desire.

In various embodiments, the lens position determination module 206 receives as input the position change data 214. The lens position determination module 206 selects one or more cameras from the cameras 19 available on the vehicle 10 as indicated by the camera data 218 to initiate the change. In various embodiments, the lens position determination module 206 selects the camera(s) 19 based on the condition that initiated the desire for a change. For example, the lens position determination module 206 selects the camera 19 identified as experiencing the unavailable view, obstructed view, or interesting object. In another example, the lens position determination module 206 selects other cameras 19 that are on a same side of the camera 19 or vehicle minor identified as experiencing the unavailable view, obstructed view, or interesting object. As can be appreciated, the cameras 19 can be selected according to a variety of conditions and the disclosure is not limited to the present examples.

The lens position determination module 206 then determines a desired position of the lens 21 of the selected camera(s) 19. For example, when the position change data 216 indicates that a vertical view is blocked or unavailable, the lens position determination module 206 determines the desired position of the lens 21 to be a vertical orientation (e.g., rotating the lens by 90 degrees from a default position) in order to increase the pixel density in the vertical direction and thus, the viewing angle for the blocked vertical view. In another example, when the position change data 216 indicates that a horizontal view is blocked or unavailable, the lens position determination module 206 determines the desired position of the lens 21 to be a horizontal orientation (e.g., rotating the lens by 90 degrees from a default position) in order to increase the pixel density in the horizontal direction and thus, the viewing angle for the blocked horizontal view. As can be appreciated, the lens position determination module 206 can determine the change to be to any position within the 360 degree rotation of the lens depending on the location of the blocked or unavailable view. The lens position determination module 206 generates lens position data 220 based on the desired position of the lens 21. The lens position data 220 is made available to image processing methods to adjust the image reading format to correspond to the position of the lens 21.

In various embodiments, the lens control module 208 receives as input the lens position data 220. The lens control module 208 determines control data 222 to control the position of the lens 21 to the position indicated by the desired position data 220. For example, the lens control module 208 determines the control data 222 based on the current position of the lens 21 and the position of the camera 19 relative to the vehicle 10 as indicated by the camera data 218. The lens control module 208 generates the control data 222 to the lens adjustment system 23 such that the desired position of the lens 21 is achieved, thereby enabling an improved field of view and pixel density for the current scenario.

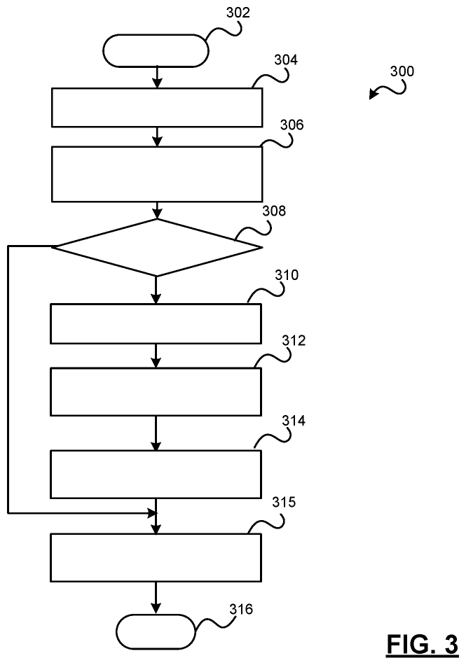

With reference now to FIG. 3 and with continued reference to FIGS. 1-2, a flowchart provides a methods 300 for controlling a position of a lens 21 of a camera 19 as performed by the camera system 100, in accordance with exemplary embodiments. As can be appreciated in light of the disclosure, the order of operation within the method 300 is not limited to the sequential execution as illustrated in FIG. 3, but may be performed in one or more varying orders as applicable and in accordance with the present disclosure. In various embodiments, the method 300 can be scheduled to run based on one or more predetermined events, and/or can run continuously during operation of the vehicle 10.

In one example, the method 300 may begin at 302. The vehicle data 212 and/or image data 210 is received at 304. The vehicle data 212 and/or image data 210 is evaluated to determine if a change in lens position is desired at 306, for example, based on the conditions discussed above. When a desire to change is not present (e.g., all cameras 19 are viewing the environment as expected) at 308, then the method 300 may end at 316.

When a desire to change is present at 308, then the method 300 continues with changing a lens position at 310-314. For example, a camera or multiple cameras of the available cameras 19 on the vehicle 10 are selected based on the condition that initiates the desire at 310, for example, as discussed above. A position of the lens 21 is determined for the selected camera or cameras 19 at 312. The lens control data 222 is then generated based on the desired position at 314. The lens position data 220 and/or the lens control data 222 may then be used by image processing methods to alter the processing of camera data to correspond to the new position of the lens 21 at 315. Thereafter, the method may end at 316.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method for controlling a position of a lens of a camera of a vehicle, comprising:
storing, in a data storage device, a first lens position associated with the lens of the camera;
receiving, by a processor, sensor data generated by at least one sensor of the vehicle;
determining, by the processor, a desire for a change in lens position based on the sensor data;
selecting, by the processor, the camera from a plurality of cameras of the vehicle based on the desire for change in lens position;
determining, by the processor, a second lens position based on conditions associated with the desire for the change in lens position and the first lens position; and
generating, by the processor, control data to control the position of the lens based on the second lens position.

2. The method of claim 1, wherein the sensor data includes image data generated by at least one of the camera and one or more other cameras of the vehicle.

3. The method of claim 1, wherein the sensor data includes vehicle data that indicates an observable condition of the vehicle.

4. The method of claim 1, wherein the determining the second lens position is further based on a position of the camera relative to the vehicle.

5. The method of claim 1, wherein the determining the desire for change in lens position is based on a determination of at least one of a full and partial blockage of at least one of the plurality of cameras.

6. The method of claim 1, wherein the determining the desire for change in lens position is based on a determination that at least one of a full and partial view from a vehicle mirror is unavailable.

7. The method of claim 1, wherein the determining the desire for change in lens position is based on a determination that an interesting object is at least one of partially or fully outside of a field of view of at least one of the plurality of cameras.

8. The method of claim 1, wherein the selecting the camera from the plurality of cameras of the vehicle is based on a condition associated with the desire for change in lens position.

9. The method of claim 8, wherein the selected camera is a camera associated with the condition.

10. The method of claim 8, wherein the selected camera is a camera other than a camera associated with the condition.

11. A system for controlling a position of a lens of a camera of a vehicle, comprising:
a non-transitory computer readable medium configured to store parameters associated with the lens; and
a computer system onboard the vehicle and configured to, by a processor:
store a first lens position associated with the lens of the camera;
receive sensor data generated by at least one sensor of the vehicle;
determine a desire for a change in lens position based on the sensor data;
select the camera from a plurality of cameras of the vehicle based on the desire for change in lens position;
determine a second lens position based on conditions associated with the desire for the change in lens position and the first lens position; and
generate control data to control the position of the lens based on the second lens position.

12. The system of claim 11, wherein the sensor data includes image data generated by at least one of the camera and one or more other cameras of the vehicle.

13. The system of claim 11, wherein the sensor data includes vehicle data that indicates an observable condition of the vehicle.

14. The system of claim 11, wherein the determination of the second lens position is further based on a position of the camera relative to the vehicle.

15. The system of claim 11, wherein the determination of the desire for change in lens position is based on a determination of at least one of a full and partial blockage of at least one of the plurality of cameras.

16. The system of claim 11, wherein the determination of the desire for change in lens position is based on a determination that at least one of a full and partial view from a vehicle mirror is unavailable.

17. The system of claim 11, wherein the determination of the desire for change in lens position is based on a determination that an interesting object is at least one of partially or fully outside of a field of view of at least one of the plurality of cameras.

18. The system of claim 11, wherein the selection of the camera from the plurality of cameras of the vehicle is based on a condition associated with the desire for change in lens position.

19. The system of claim 18, wherein the selected camera is a camera associated with the condition.

20. The system of claim 18, wherein the selected camera is a camera other than a camera associated with the condition.
